(19) United States
(12) Patent Application Publication
(10) Pub. No.: US 2021/0246084 A1
(43) Pub. Date: Aug. 12, 2021

(54) Fertilizer Pouch and Method of Use Thereof

(71) Applicants: Kenneth G. Lander, Pugwash (CA); Aaron Spencer, Pugwash (CA)

(72) Inventors: Kenneth G. Lander, Pugwash (CA); Aaron Spencer, Pugwash (CA)

(73) Assignees: Kenneth G. Lander, Pugwash (CA); Aaron G. Spencer, Pugwash (CA)

(21) Appl. No.: 17/167,716

(22) Filed: Feb. 4, 2021

Related U.S. Application Data
(60) Provisional application No. 62/975,109, filed on Feb. 11, 2020.

(51) Int. Cl. C05G 5/00; C05G 3/40; C05C 11/00; C08L 1/02; C05F 11/08

(52) U.S. Cl. CPC C05G 5/45; C05G 3/40; C08L 2201/06; C08L 1/02; C05F 11/08; C05C 11/00

(57) ABSTRACT

There is provided a fertilizer pouch for planting on or in soil. The fertilizer pouch comprises an enclosed biodegradable container having sidewalls surrounding an interior space and fertilizer situated within the interior space. Upon planting, the biodegradable container degrades and releases the fertilizer therein into the surrounding soil. There is also provided a method of applying fertilizer to soil, the method comprises planting one or more of the above fertilizer pouches in or on the soil, wherein the biodegradable containers degrade at different rates, thus releasing the fertilizer therein into the surrounding soil at different times.

### CROSS REFERENCE TO RELATED APPLICATIONS

This application claims priority to U.S. Provisional Application No. 62/975,109 filed Feb. 11, 2020 which is incorporated herein by reference.

### FIELD

This invention relates generally to fertilizers, and more particularly to biodegradable fertilizer pouches.

### BACKGROUND OF THE INVENTION

Fertilizers are often applied to soil in and around plants to supply nutrients that are important to the growth of the plants. However, their application must be controlled. Over-fertilization can burn or be poisonous to the plants, while under-fertilization may limit the growth potential of the plants. Over time, fertilizer not immediately taken up by plants may tend to naturally degrade due to microbes in the soil and/or be washed away.

One potential solution is the use of slow release or controlled release fertilizers. However, control or slow release fertilizers usually require special formulation (such as use of compounds with low solubility), and/or specific configurations (such as fertilizer in tablet form). Thus, special equipment is usually

required in order to produce slow release fertilizers, making them generally more expensive than regular or quick release fertilizers.

### SUMMARY OF THE INVENTION

In one aspect of the invention there is provided a fertilizer pouch for planting on or in soil, the fertilizer pouch comprising: an enclosed biodegradable container having sidewalls surrounding an interior space; and fertilizer situated within the interior space; wherein upon planting, the biodegradable container degrades and releases the fertilizer therein into the surrounding soil.

In another aspect of the invention, there is also provided a method of forming a fertilizer pouch for planting in soil, the method comprising: providing a biodegradable container having sidewalls forming an opening and surrounding an interior space, the opening in communication with the interior space; injecting fertilizer into the interior space; and sealing the opening; wherein upon planting, the biodegradable container degrades and releases the fertilizer therein into the surrounding soil.

In another aspect of the invention, there is further provided a method of applying fertilizer to soil, the method comprising: planting a first fertilizer pouch in or on the soil, the first fertilizer pouch comprising: a first biodegradable container having sidewalls surrounding a first interior space; and fertilizer situated within the first interior space; wherein the first biodegradable container degrades and releases the fertilizer therein into the surrounding soil.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is a plan view of a fertilizer pouch according to an embodiment of the present invention.

FIG. 2 is a cross-sectional view of the fertilizer pouch of FIG. 1 along line 2-2.

FIG. 3 is a plan view of a fertilizer pouch according to another embodiment of the present invention.

FIG. 4 is a cross-sectional view of the fertilizer pouch of FIG. 3 along line 4-4.

FIG. 5 is a cross-sectional view of plan view of a plant in a pot with the fertilizer pouches of FIGS. 2 and 4 in use.

FIG. 6 is a view of FIG. 5 with the fertilizer pouch of FIG. 2 partially degraded.

FIG. 7 is a view of FIG. 6 with the fertilizer pouch of FIG. 2 fully degraded.

FIG. 8 is a view of FIG. 7 with the fertilizer pouch of FIG. 4 partially degraded.

FIG. 9 is a view of FIG. 8 with the fertilizer pouch of FIG. 4 fully degraded.

### DESCRIPTION OF THE INVENTION

The present invention may be embodied in a number of different forms. The specification and drawings that follow describe and disclose some of the specific forms of the invention.

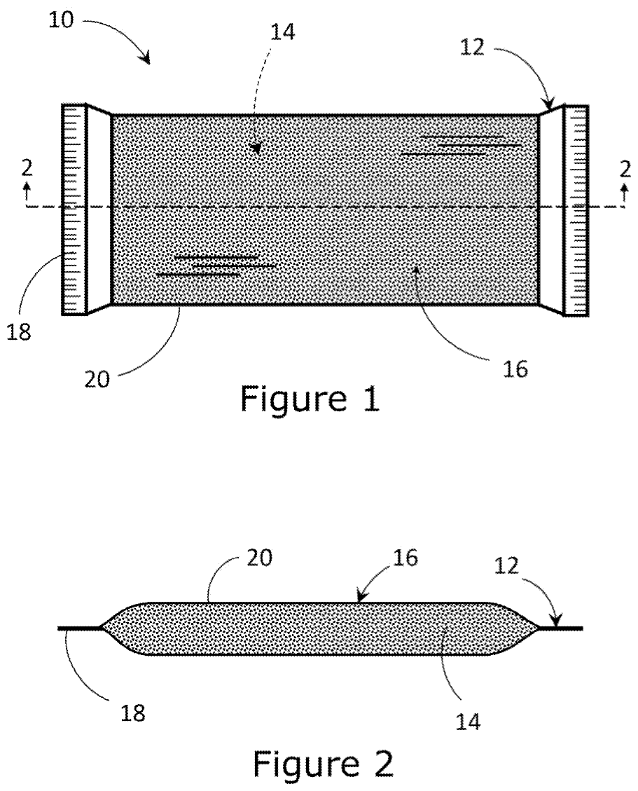

Examples of a fertilizer pouch 10 for planting on or in soil are illustrated in FIGS. 1-4. Fertilizer pouch 10 generally includes a biodegradable container 12 with fertilizer 14 contained therein.

Biodegradable container 12 includes sidewalls 16 with sealed ends 18, which collectively surround an interior space. While biodegradable container 12 may be made from a wide variety of biodegradable materials, such as paper, in the depicted embodiments, biodegradable container 12 is made from regenerated cellulose, such as C₆H₁₀O₅. In the particular embodiment of FIGS. 1 and 2, biodegradable container 12 is made from cellophane 20, produced by Futamura™.

As will be understood by the skilled person, cellophane is a thin and often transparent bioplastic. Given its low permeability to air, oils, water, and bacteria, cellophane is currently commonly used as packaging for food. Since cellophane is made from regenerated plant cellulose, it is biodegradable and compostable, especially upon dampening. Thus, when fertilizer pouch 10 is planted in or on soil, biodegradable container 12 degrades and releases fertilizer 14 contained therein into the surrounding soil.

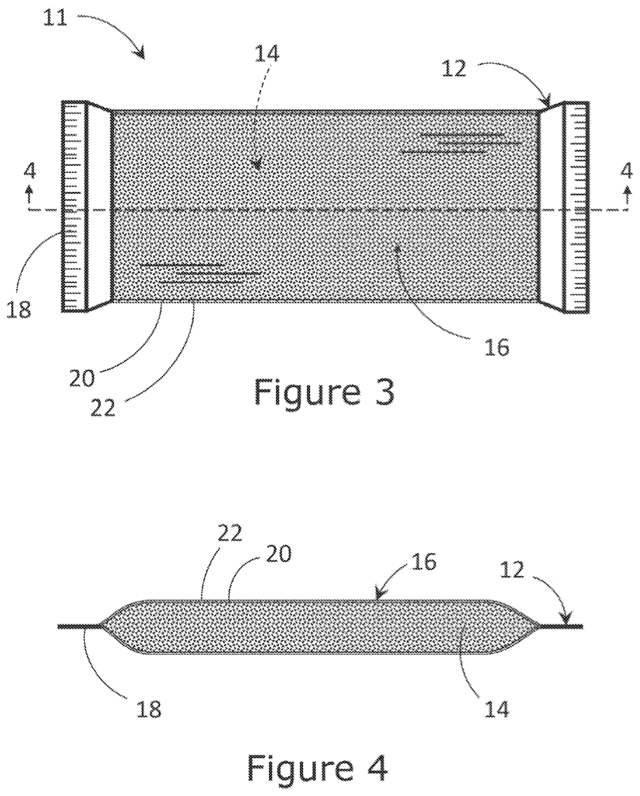

In the particular embodiment of FIGS. 3 and 4, where the fertilizer pouch is referred to with reference character 11, biodegradable container 12 is also made from cellophane 20, in its thin and transparent sheet form. In addition, however, sidewalls 16 may also be coated with nitro-cellulose 22. Cellophane is permeable to water vapour. In order to slow or inhibit the cellophane's water vapour permeability, and by extension its degradation, a nitro-cellulose coating may be used to reduce the permeability of the cellophane and, thus, slows its rate of degradation.

In the depicted embodiment, cellophane 20 is coated with nitro-cellulose 22 on the inside of fertilizer pouch 11. In alternate embodiments, cellophane 20 may be coated with nitro-cellulose 22 on the outside of the pouch. In further alternate applications, rather than a nitro-cellulose coating, another biodegradable and water vapour impermeable coating may be used, such as a wax coating.

Biodegradable container 12 may be made from different biodegradable materials, with or without different biodegradable coatings, depending on the desired rate of degradation. The placement of the biodegradable coating may also affect the rate of degradation. For example, breakdown of biodegradable container 12 may be slower if the biodegradable coating were positioned on the outside of biodegradable container 12, rather than on the inside. In that manner, the biodegradable coating may act as a temporary moisture barrier to further slow the degradation of the cellophane or paper within.

As well, while biodegradable container 12 is shown to have a rectangular shape, as will be understood by the skilled person, biodegradable container 12 may instead have a different shape, such as a spherical, cylindrical, or asymmetric shape.

Fertilizer 14 sits, or is positioned, within the interior space of biodegradable container 12. Fertilizer 14 may comprise of a variety of different organic fertilizers, permutations, and/or combinations thereof. In certain applications, the fertilizer composition will likely vary according to the plant or crop it is to be used with. For example, fertilizer 14 may comprise of one or more of hen manure, bone meal, feather meal, potash, worm castings, greensand, volcanic rock dust, and Pro Mix™.

In the present embodiments, fertilizer 14 includes a high nitrogen blend, for example, 9% or more nitrogen by weight. In some applications, the fertilizer 14 may include 9% or 10% nitrogen by weight. The present fertilizer 14 may also include bacteria to aid in the breakdown of the biodegradable container 12. For example, Bacillus thurengensis israeliensis var 14 may be added for control of fungus gnats.

Cellophane biodegrades, or is broken down, by microorganisms, such as bacteria and fungi. The presence of the additional nitrogen and bacteria in fertilizer 14 within cellophane 20 may help to accelerate the breakdown of biodegradable container 12, especially upon dampening.

Since fertilizer pouch 10 is inherently a single use product, the amount of fertilizer 14 contained within biodegradable container 12 may be adjusted depending on the type and number of plants fertilizer pouch 10 will be “serving”. For example, in ten to twenty litres of potting mix, a single fertilizer pouch 10 with 125 grams of fertilizer 14 may provide two months of nutrition for a plant therein. In larger pots or volumes of soil, fertilizer pouch 10 may contain 300 grams of fertilizer 14. As would be understood by the skilled person, the amount of fertilizer 14 in biodegradable container 12 may vary depending on the volume of soil to be fertilized.

Given the ready abundance of cellophane and organic fertilizers, the production of fertilizer pouch 10 may be simple and inexpensive. In one such method of production, a user simply has to procure or form a biodegradable container that has sidewalls which form an opening, and which surround an interior space, where the opening is in communication with the interior space. A number of different desired fertilizers may then be injected or poured into the interior space. If regenerated cellulose or cellophane is used, the opening may be heat sealed, thus no additional adhesives would be required. If a slower rate of biodegradation is desired, cellophane with a nitro-cellulose coating may be used.

As discussed above, additional nitrogen and/or bacteria may be added to the fertilizer that is injected or poured into the interior space. Since the “slow release mechanism” of the present subject matter depends on the degradation of biodegradable container 12, the fertilizer used need not require any other special ingredients or formulation in order for the fertilizer to slow-release into the soil.

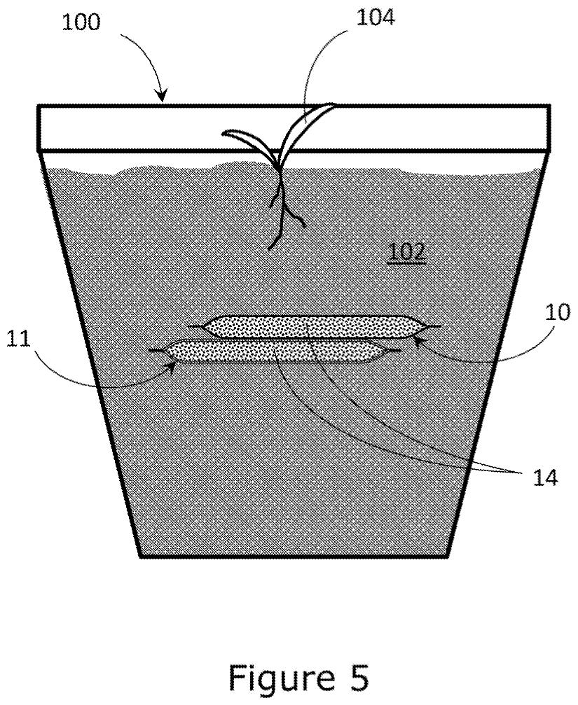

Turning now to FIGS. 5 to 9, there is illustrated an example of a method and use of fertilizer pouch 10. Fertilizer pouch 10 may be planted or buried in a pot 100, or directly in soil 102, before a plant 104 is planted. In alternate applications, fertilizer pouch 10 may be implanted or mixed in soil 102 after plant 104 is planted, or dressed on top of soil 102.

As shown in FIG. 5, a fertilizer pouch 10 without nitro-cellulose coating 22, and a fertilizer pouch 11 with nitro-cellulose coating 22, has been planted in pot 100. Once fertilizer pouches 10 and 11 have been planted, soil 102 provides an environment that inherently starts to help break down biodegradable container 12. For example, soil 102 tends to naturally contain bacteria and water vapour. The bacteria in soil 102 may begin breaking down biodegradable container 12 from the outside, while the bacteria in fertilizer 14 within biodegradable container 12 (if present) may begin breaking down the container from the inside. The water vapour in soil 102 can also permeate through cellophane 22 to activate the nitrogen contained in fertilizer 14 to aid in the cellophane break down.

In other words, cellophane 22 is essentially “dissolving” due to the bacterial action. This process may use extra nitrogen, hence it may be desirable to add extra nitrogen to fertilizer 14. The nitrogen will then return to the soil after cellophane 22 breaks down.

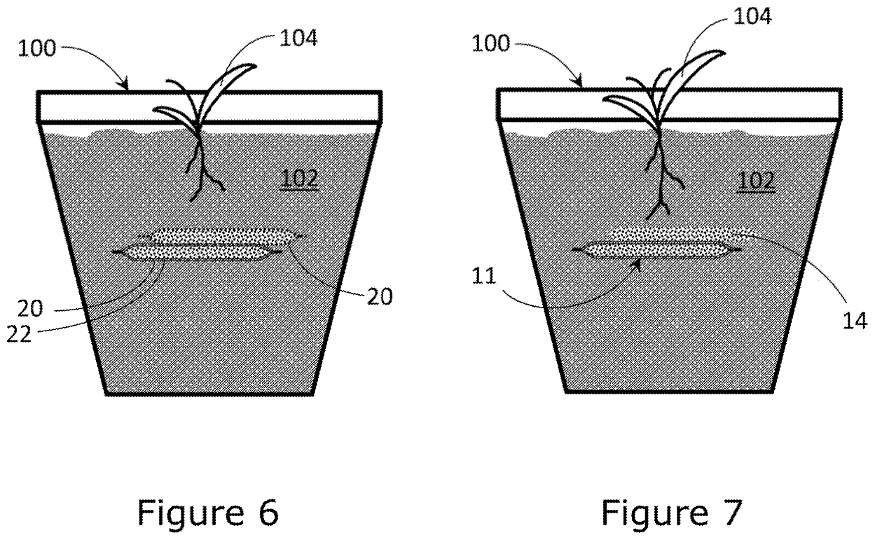

In the case of uncoated fertilizer pouch 10, cellophane 22 may begin to break down in 2-3 weeks in ambient or room temperature, and moist conditions, such as at 70° F. (see FIG. 6, for example). Un-glossed, porous paper may also break down in 2-3 weeks under similar conditions.

Once the uncoated cellophane degrades, fertilizer 14 is released into surrounding soil 102 for uptake by plant 104. The 2-3 week timeframe may be selected to coincide with the growth of the plant's roots (see FIG. 7, for example). As noted above, fertilizer 14 may be formulated to actively deliver nutrients to plant 104 for 2 months.

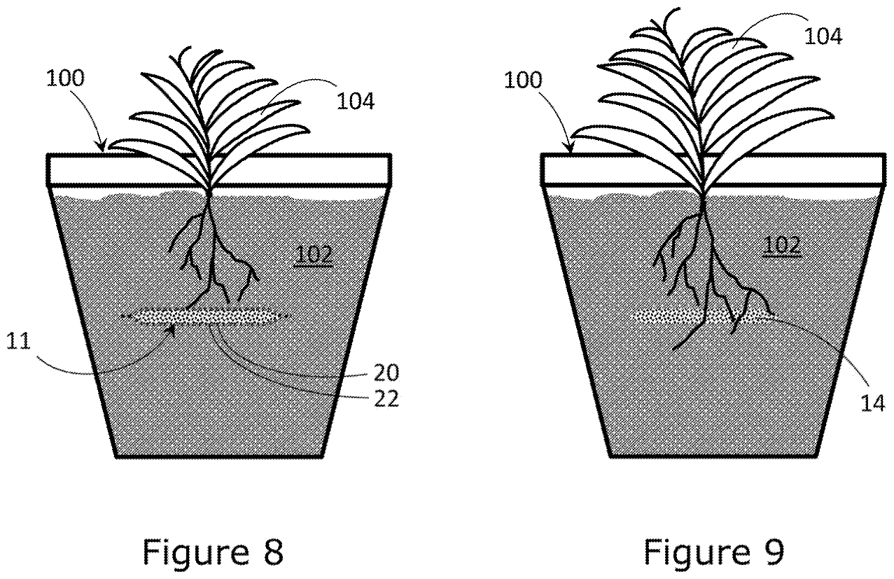

In the case of coated fertilizer pouch 11, the coated cellophane may begin to break down in 2-3 months in ambient or room temperature in moist conditions, such as at 70° F. (see FIG. 8, for example). The presence of cellophane 22 may also aid in preventing the leaching of nutrients into soil 102 before cellophane 22 degrades.

Once the coated cellophane degrades, fertilizer 14 contained inside is released into surrounding soil 102 for uptake by plant 104. See FIG. 9, for example. The 2-3 month time frame may be selected to coincide with the time that nutrients in fertilizer 14 from uncoated fertilizer pouch 10 will deplete, i.e. 2 months from its release. In this manner, plant 104 may have access to a constant source of nutrients over several months, such as up to 5 months from planting.

One advantage of the present subject matter is that it allows regular or quick release fertilizers to have slow release properties in a cost-efficient manner.

Since biodegradable container 12 may be made from different biodegradable materials, with or without different biodegradable coatings, with the biodegradable coatings applied to the interior or exterior of biodegradable container 12, differing rates of degradation may be achieved depending on the choice of materials. Different rates of degradation of different biodegradable container 12 allow for the release of the fertilizer contained therein into surrounding soil 102 at different times.

While the use of two fertilizer pouches 10 and 11 is shown, three or more fertilizer pouches 10 may be planted in use. Use of multiple fertilizer pouches 10, each with different rates of biodegradation, helps to allow nutrients to be more evenly and slowly released into soil 102 for extended periods of time. Fertilizer pouches 10 may also be dressed on top of soil 102 along with, or instead of, the buried fertilizer pouches 10 and 11.

As well, fertilizer pouches 10 and 11 may contain different fertilizers 14. In this manner, different fertilizer compositions may be released to plant 104 at different stages of its growth.

It is to be understood that what has been described are the preferred embodiments of the invention. The scope of the claims should not be limited by the preferred embodiments set forth above, but should be given the broadest interpretation consistent with the description as a whole.

1. A fertilizer pouch for planting on or in soil, the fertilizer pouch comprising:
an enclosed biodegradable container having sidewalls surrounding an interior space; and
fertilizer situated within the interior space;
wherein upon planting, the biodegradable container degrades and releases the fertilizer therein into the surrounding soil.

2. The fertilizer pouch of claim 1, wherein the biodegradable container is made from regenerated cellulose.

3. The fertilizer pouch of claim 1, wherein the biodegradable container is made from cellophane.

4. The fertilizer pouch of claim 1, wherein the sidewalls are coated with nitro-cellulose.

5. The fertilizer pouch of claim 1, wherein the volume of fertilizer contained within the interior space is 125 grams or less.

6. The fertilizer pouch of claim 1, wherein 9% or more of the fertilizer by weight is nitrogen.

7. The fertilizer pouch of claim 1, wherein the fertilizer comprises bacteria to assist in the breakdown of the biodegradable container.

8. The fertilizer pouch of claim 7, wherein the bacteria is Bacillus thurengensis israeliensis var 14.

9. A method of forming a fertilizer pouch for planting in or on soil, the method comprising:
providing a biodegradable container having sidewalls with an opening therethrough and surrounding an interior space, the opening in communication with the interior space;
injecting fertilizer into the interior space; and
sealing the opening;
wherein upon planting, the biodegradable container degrades and releases the fertilizer into the surrounding soil.

10. The method of claim 9, wherein the sidewalls are formed from cellophane.

11. The method of claim 9, wherein the sidewalls are coated with nitro-cellulose.

12. The method of claim 9, wherein 125 grams of fertilizer or less are injected into the interior space.

13. The method of claim 9, wherein the fertilizer contains 9% or more of nitrogen by weight.

14. The method of claim 9, further comprising adding bacteria to the fertilizer to assist in the breakdown of the biodegradable container.

15. A method of applying fertilizer to soil, the method comprising:
planting a first fertilizer pouch in or on the soil, the first fertilizer pouch comprising:
a first biodegradable container having sidewalls surrounding a first interior space; and
fertilizer situated within the first interior space;
wherein the first biodegradable container degrades and releases the fertilizer therein into the surrounding soil.

16. The method of claim 15, further comprising planting a second fertilizer pouch in or on the soil, the second fertilizer pouch comprising
a second biodegradable container having sidewalls surrounding a second interior space; and
fertilizer situated within the second interior space;
wherein the second biodegradable container degrades at a different rate than the first biodegradable container and releases the fertilizer therein into the surrounding soil at a different rate than the first biodegradable container.

17. The method of claim 16, wherein the second biodegradable container degrades at a slower rate than the first biodegradable container and releases the fertilizer therein into the surrounding soil after fertilizer within the first biodegradable container is released into the surrounding soil.

18. The method of claim 17, wherein the first biodegradable container is cellophane and 9% or more of the fertilizer by weight is nitrogen.

19. The method of claim 18, wherein the second biodegradable container is cellophane with a nitro-cellulose coating, and 9% or more of the fertilizer by weight is nitrogen.

20. The method of claim 16, wherein the fertilizer within the second biodegradable container is different from the fertilizer within the first biodegradable container.
